(19) United States
(12) Patent Application Publication
(10) Pub. No.: US 2016/0190538 A1
(43) Pub. Date: Jun. 30, 2016

(54) CONDUCTIVE AND LIQUID-RETAINING STRUCTURE

(71) Applicant: Hyundai Motor Company, Seoul (KR)

(72) Inventors: Yoon Ji LEE, Bucheon-si (KR); Hee Yeon RYU, Yongin-si (KR); Dae Gun JIN, Suwon-si (KR); Sang Jin PARK, Bucheon-si (KR)

(21) Appl. No.: 14/949,375

(22) Filed: Nov. 23, 2015

(30) Foreign Application Priority Data
Dec. 30, 2014 (KR) 10-2014-0194119

(51) Int. Cl. H01M 2/16; H01M 2/14; H01M 10/052

(52) U.S. Cl. CPC H01M 2/1673; H01M 2/1686; H01M 10/052; H01M 2/145

(57) ABSTRACT

A lithium-sulfur secondary battery includes a positive electrode, a conductive and liquid-retaining structure, and a positive electrode. The conductive and liquid-retaining structure has a thickness of 5 to 100 μm, an areal weight of 10 to 120 g/m², and a porosity of 70 to 95% and is coated with a hydrophilic polymer.

### CROSS-REFERENCE TO RELATED APPLICATION

This application claims under 35 U.S.C. §119(a) the benefit of priority to Korean Patent Application No. 10-2014-0194119 filed on December 30, 2014, the entire content of which is incorporated herein by reference.

### TECHNICAL FIELD

The present disclosure relates to a structure for liquid-retaining an electrolyte in a secondary battery.

### BACKGROUND

A secondary battery is a battery in which chemical energy and electric energy are converted into each other through chemical reaction of oxidation and reduction and charging and discharging are repeated, and generally includes four basic elements of a positive electrode, a negative electrode, a separation membrane, and an electrolyte. The positive electrode and the negative electrode are collectively referred to as electrodes, and a material which actually causes a reaction among constituent elements of an electrode material is also referred to as an active material.

Among the secondary batteries, a lithium-sulfur battery has received attention as a next-generation battery candidate due to a high energy density to mass. The lithium-sulfur battery uses a sulphur positive active material and a lithium metal as a negative active material. A theory capacity of sulphur as the positive active material is very high as 1675 mAh/g, but an actually expressed capacity is much lower than the theory capacity due to various problems.

In the lithium-sulfur battery, sulphur is melt and discharged in the electrolyte in a Li-polysulfide (Li-PS) form during a charge/discharge reaction process. When the Li-PS melt and discharged in the electrolyte by the reduction passes through the separation membrane and then moves to the negative electrode to cause an unnecessary reaction in the negative electrode, a charging delay phenomenon is shown and called a shuttle phenomenon which reduces a lifespan of the battery. In addition, when the Li-PS moving to the negative electrode is reduced and deposited to Li₂S and Li₂S₂ as a nonconductor in the negative electrode, a loss of the active material is caused to reduce the battery capacity.

As a result of a cell design suitable for a high-energy density target value, since a high-loading positive electrode is required, it is difficult to express the battery capacity. Accordingly, an electrolyte retaining liquid is required toward the high-loading positive electrode, and it is well-known to express the capacity in an electrode of high-loading (2.5 mg/cm2_S) or more when a glass filter (G/F) is inserted.

However, a reaction site in the secondary battery using the positive electrode having loading of 5 mg/cm²_S or more is not sufficient by only a liquid-retaining structure of the G/F structure.

The separation membrane used in the secondary battery has an insulating property to prevent the negative electrode and the positive electrode from being short-circuited while penetrating lithium ions and the electrolyte. Generally, a polyolefin-based separation membrane is used and Li ions move and Li-PS may simultaneously move to pores existing in the membrane.

However, since a cell lifespan is not efficiently extended by only the prevention of a secondary shuttle phenomenon by the separation membrane, a technique of preventing the secondary shuttle phenomenon is required in the positive electrode itself.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with prior art.

The present disclosure has been made in an effort to provide an electrolyte liquid-retaining structure in a secondary battery having advantages of enhancing performance of the battery by expressing a capacity of the battery and providing a reaction site.

Further, the present disclosure has been made in an effort to provide a liquid-retaining structure which serves as the liquid-retaining structure and a protective layer of the positive electrode itself preventing a shuttle phenomenon.

According to an exemplary embodiment of the present inventive concept, a lithium-sulfur secondary battery includes a positive electrode, a conductive and liquid-retaining structure, and a positive electrode. The conductive and liquid-retaining structure has a thickness of 5 to 100 μm, an areal weight of 10 to 120 g/m², and a porosity of 70 to 95% and is coated or laminated with a hydrophilic polymer.

According to another exemplary embodiment of the present inventive concept, a lithium-sulfur secondary battery includes a positive electrode, a conductive and liquid-retaining structure, and a positive electrode. The conductive and liquid-retaining structure has a thickness of 5 to 100 μm, an areal weight of 10 to 120 g/m², and a porosity of 70 to 95% and is laminated with a hydrophilic polymer.

The hydrophilic polymer may be one or more selected from the group consisting of polyethylene glycol (PEG), polystyrene sulfonate (PSS), poly(3,4-ethylenedioxythiophene) (PEDOT), polythylene oxide (PEO), polyvinylpyrrolidone (PVP), polyacrylic acid (PAA), polyvinyl alcohol (PVA), and a copolymer thereof.

The conductive and liquid-retaining structure may be assembled with a negative electrode and a separation membrane after casting and laminating an active material on the positive electrode or assembled between the separation membrane and the positive electrode in a cell assembling process.

The conductive and liquid-retaining structure is a carbon paper, a carbon felt, a carbon veil, a gas diffusion layer (GDL), a carbon nanotube paper, or a laminated structure of two or more selected from the carbon paper, the carbon felt, the carbon veil, the GDL, and the carbon nanotube paper.

According to another exemplary embodiment of the present inventive concept, a method of manufacturing a lithium-sulfur secondary battery including a positive electrode, a conductive and liquid-retaining structure, and a positive electrode, in which the conductive and liquid-retaining structure is assembled with a negative electrode and a separation membrane after casting and laminating an active material on the positive electrode. The conductive and liquid-retaining structure has a thickness of 5 to 100 μm, an areal weight of 10 to 120 g/m², and a porosity of 70 to 95% and is coated with a hydrophilic polymer.

In order to achieve the high energy density, a high-loading electrode is required, but since a larger amount of PSs moves with higher loading, sulfur utilization deteriorates. Accordingly, it is important to store the PS well.

The present invention may enhance sulfur utilization (PS loss prevention) by selectively leaving the PS around the positive electrode.

Further, the lifespan of the battery is increased by preventing the PS loss, and as a result, in the PS suppression of an existing micro or nano scale, PS suppression of a cell unit is possible and thus mass production and actual applicability are increased.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not !imitative of the present disclosure

FIG. 1 schematically illustrates a general method of manufacturing a positive electrode.

FIG. 2 schematically illustrates a method of assembling electrodes which apply a conductive structure of the present disclosure.

FIGS. 3A-3D schematically illustrate a carbon paper, ketjenblack, and a conductive material film having a high specific surface area, or a carbon structure layer composing the carbon paper, the ketjenblack, and the conductive material film.

FIGS. 4A-4C are an assembling schematic diagram of a positive electrode using a conductive and liquid-retaining structure to which a hydrophilic polymer is applied and a schematic diagram in which the structure prevents a polysulfide shuttle phenomenon.

FIGS. 5A and 5B are a model of a polymer-modified CMK-3/S composite in the related art (“Linda F. Nazar. et al. NATURE MATERIALS 8, 500-506 (2009)”) and a result graph obtained by increasing charge/discharge efficiency by preventing polysulfide from being dissolved in an electrolyte through hydrophilicity of a CMK3 surface.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present inventive concept, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

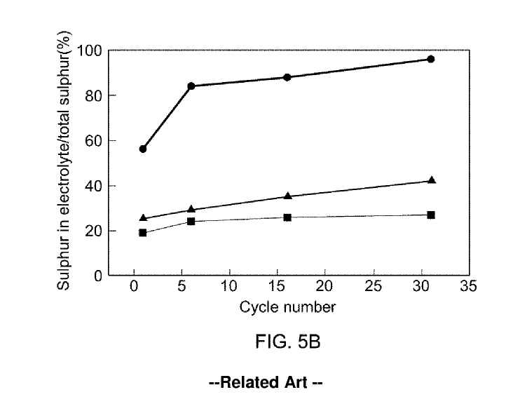

In the reference, <Linda F. Nazar. et al. NATURE MATERIALS 8, 500-506 (2009)>, it is disclosed that as a polymer-modified CMK-3/S composite (see FIGS. 5A and 5B), a polyethylene glycol (PEG) chain is attached onto a CMK3 (OMC) surface.

In detail, the document is a technique to prevent polysulfide from being dissolved in an electrolyte through hydrophilicity of the CMK3 surface and to suppress polysulfide (PS) release (modification of a conductive material) in the sulfur electrode.

As reported in the document, a PS concentration (see the graph of FIGS. 5A and 5B) in the electrolyte according to a positive electrode composite is:

Black: the CMK-315-PEG composite negative electrode;

Blue: the CMK-3/S composite negative electrode; and

Red: a mixture of acetylene black carbon and sulfur with the exact same C/S ratio.

The PS concentration suggests possibility of suppressing the PS release.

However, since the technique is a micro or nano scale, there is a fundamental limit in that mass production and actual application are difficult.

As a result, the present disclosure provides a lithium-sulfur secondary battery including a positive electrode, a conductive and liquid-retaining structure, and a positive electrode, in which the conductive and liquid-retaining structure has a thickness of 5 to 100 μm, an areal weight of 10 to 120 g/m², and a porosity of 70 to 95% and is coated or laminated with a hydrophilic polymer.

The hydrophilic polymer may be one or more selected from the group consisting of polyethylene glycol (PEG), polystyrene sulfonate (PSS), poly(3,4-ethylenedioxythiophene) (PEDOT), polythylene oxide (PEO), polyvinylpyrrolidone (PVP), polyacrylic acid (PAA), polyvinyl alcohol (PVA), and a copolymer thereof.

The conductive and liquid-retaining structure may be carbon paper, carbon felt, carbon veil, a gas diffusion layer (GDL), carbon nanotube paper, or a laminated structure of two or more kinds selected from carbon paper, carbon felt, carbon veil, a gas diffusion layer (GDL), and carbon nanotube paper. A loading amount of the positive electrode may be 3 to 10 mg/cm².

The conductive and liquid-retaining structure may be assembled with a negative electrode and a separation membrane after casting and laminating the active material on the positive electrode or assembled between the separation membrane and the positive electrode in a cell assembling process.

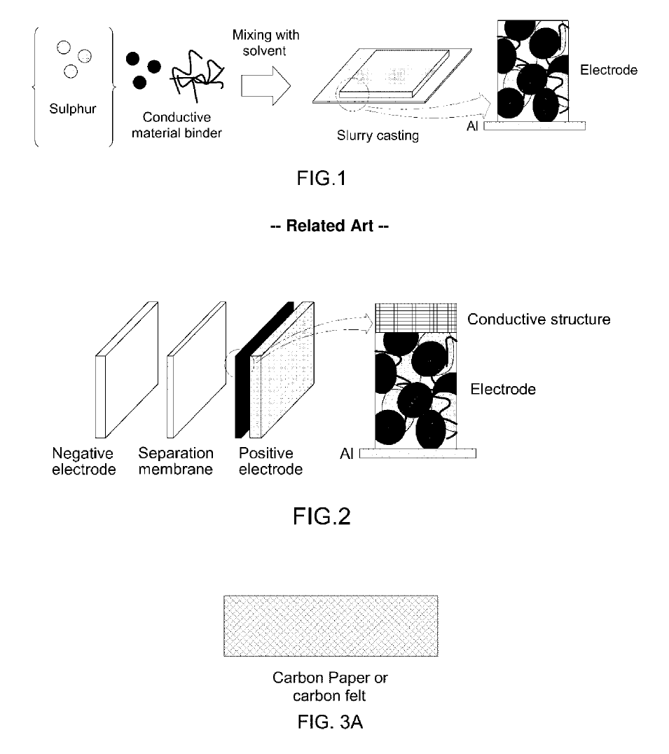

The conductive and liquid-retaining structure according to the present invention includes combination of the positive electrode (regardless of any combination and regardless of Al-casting), the conductive and liquid-retaining structure, and the hydrophilic polymer of the secondary battery. Any carbon structure layer having a porosity, a pore size, and a thickness proposed in the present disclosure is also included in the scope of the present disclosure. A positive electrode of a lithium-sulfur battery in the related art comprises an electrode while an active material, a conductive material, and a binder are mixed and then cast in a substantially homogeneous state (see FIG. 1).

An electrode assembling method in the related art uses a method of configuring a cell by the negative electrode, the separation membrane, the positive electrode, and the electrolyte. When an active material is transformed into an electrolyte-soluble material as the PS during reaction and melted and output to the electrolyte, an active material loss rate increases and a lifespan keeping rate deteriorates.

Further, performance of a charge/discharge cell in which the active material is highly loaded (high-loading electrode) is not expressed.

In the positive electrode including a conductive structure of the present disclosure, the positive electrode is manufactured by casting a positive active material on metal (for example, an aluminum substrate) like FIG. 2. Simultaneously, a carbon structure layer having a specific surface area and a porosity in a range proposed in the present disclosure is assembled as the conductive structure to be assembled as the entire electrode. Alternatively, the positive electrode is first manufactured and the entire electrode is assembled in the order of the negative electrode, the separation membrane, the conductive structure, and the positive electrode to configure the cell.

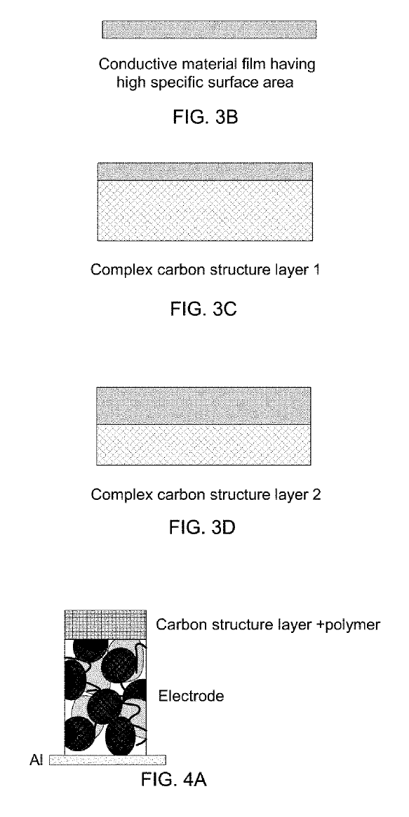

A kind of assembled conductive structure is not limited and may be commercialized and directly manufactured (see FIGS. 3A-3D). For example, the assembled conductive structure may be a carbon paper, a carbon felt, a carbon veil, a gas diffusion layer (GDL), and a carbon nanotube paper (CNT paper).

A conductive material for the conductive structure may be a carbon fiber, ketjenblack (KB), a super C, and the like and is not limited thereto.

A thickness of the conductive structure may be 5 to 1,000 μm. In some embodiment, the thickness of the conductive structure may be 50 to 500 μm for liquid-retaining. For the lifespan and reactivity, the thickness does not need to be increased and may be 20 to 350 μm.

The structure of the conductive structure may include one or more laminated with a plurality of conductive structures. The specific surface area and the porosity may be controlled by various conductive structures.

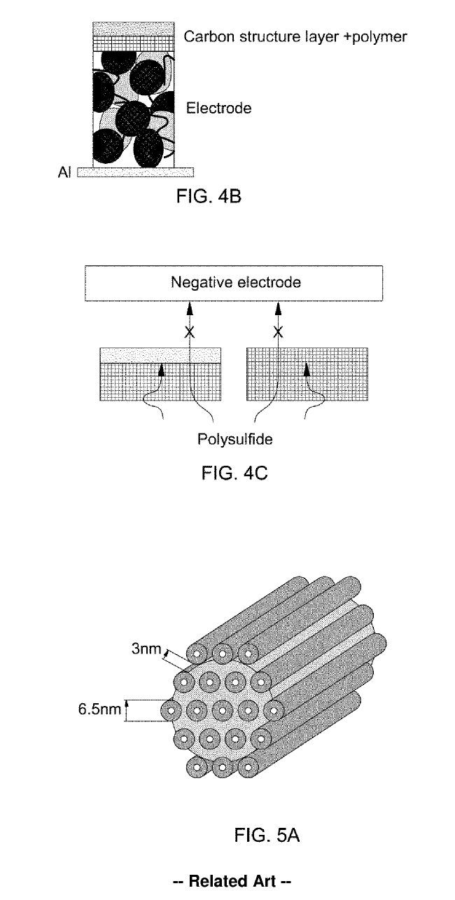

A process of introducing the hydrophilic polymer (see FIGS. 4A-4C) to the conductive and liquid-retaining structure of the present disclosure is as follows.

Polymer coating on the conductive and liquid-retaining structure may be performed by a general coating method such as dip coating and spray coating.

The polymer coating is directly performed at the positive electrode and may be used with a positive protective layer and may be used by inserting a polymer-coated carbon structure layer.

The amount of the polymer may be 2 to 50 wt % as compared with the conductive material, and a kind of polymer may use a hydrophilic polymer such as PEG, PSS, PEDOT, PEO, PVP, PAA, PVA, and a copolymer thereof. The hydrophilic polymer may be designed to be always left around the positive electrode.

In order to improve energy density, it is required to increase the active material in which the high-loading positive electrode is required. Currently, since a lithium sulfur system has a mechanism in which the active material is melted and output to the electrolyte, in a case of a high-loading active material, as compared with a low-loading electrode under the same condition, active material utilization deteriorates and it is difficult to implement cell performance. Accordingly, in order to achieve the high energy density, expression of the cell performance of the high-loading electrode is required.

When the conductive structure of the present disclosure is used, a sufficient amount of electrolyte suitable for the high-loading electrode may be liquid-retained. Further, since the electrolyte may be liquid-retained, a battery mechanism is different from that of an existing cell in which when the PS (an intermediate product) is dissolved and discharged from the positive electrode to be discharged to the negative electrode or another void volume, a capacity loss is caused next time. Since the electrolyte storing the PS may be liquid-retained, the amount of the PS discharged to the negative electrode or another void volume may be significantly reduced. Furthermore, the cell performance of the high-loading electrode may be expressed by the conductive structure.

In another feature of the present disclosure, the liquid-retaining structure includes a conductive material as a reaction site, and as a result, large performance is achieved as compared with simply liquid-retaining the PS in terms of the lifespan.

Even though the high-loading cell is expressed, the amount of released PS is increased and the lifespan is not good, and since the conductive structure serves as the reaction site, the lifespan in the high-loading cell is improved.

In order to achieve the high energy density, expression of cell performance of a high-loading electrode is required, but since a large amount of PS moves, sulfur utilization deteriorates. Accordingly, it is important to store the PS well.

The structure according to the present disclosure may enhance sulfur utilization (PS loss prevention) by selectively leaving the PS around the positive electrode.

Further, the lifespan of the battery is increased by preventing the PS loss, and as a result, in the PS suppression of an existing micro or nano scale, PS suppression of a cell unit is possible, and thus, mass production and actual applicability are increased.

### EXAMPLE

1) Preparation of Cell

A basic positive electrode was prepared by slurry coating by mixing VGCF:sulphur:PVdF=7:2:1. It was evaluated that a sulphur loading amount was 4 mg/cm²_S.

For a liquid-retaining structure of the positive electrode, a carbon fiber having a thickness of 400 μm and a porosity of 70% and carbon having a large specific surface area (800 m²/L) such as KB are used.

The positive protective layer used PEG, PSS, PEDOT, PEO, PVP, PAA, PVA, and a copolymer thereof as the hydrophilic polymer and performed a coating process of a spray method when applying the carbon structure layer (liquid-retaining structure) together.

2) Evaluation of Cell Performance

Evaluation comparison of charge/discharge and lifespan (0.2 C-rate) according to application of the positive protective layer was illustrated in the following Table 1.

TABLE 1

| | Primary | | |
|---|---|---|---|
| | discharging | | Coulombic |
| | capacity | Retention capacity | efficiency |
| | (mAh/g_S) | (50^{th}) | (50^{th}) |
| Use only | 1,000 | 50% | 108.2% |
| general | | | |
| electrode | | | |
| Insert general | 1,200 | 80% | 101% |
| electrode + | | | |
| carbon structure | | | |
| layer | | | |
| General | 970 | 80% | 101% |
| electrode + | | | |
| positive | | | |
| protective layer | | | |
| General | 1,100 | 90% | 100% |
| electrode + | | | |
| carbon structure | | | |
| layer + positive | | | |
| protective layer | | | |

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A lithium-sulfur secondary battery including a positive electrode, a conductive and liquid-retaining structure, and a positive electrode, wherein the conductive and liquid-retaining structure has a thickness of 5 to 100 μm, an areal weight of 10 to 120 g/m², and a porosity of 70 to 95% and is coated with a hydrophilic polymer.

2. A lithium-sulfur secondary battery including a positive electrode, a conductive and liquid-retaining structure, and a positive electrode,
wherein the conductive and liquid-retaining structure has a thickness of 5 to 100 μm, an areal weight of 10 to 120 g/m², and a porosity of 70 to 95% and is laminated with a hydrophilic polymer.

3. The lithium-sulfur secondary battery of claim 1, wherein the hydrophilic polymer is one or more selected from the group consisting of polyethylene glycol (PEG), polystyrene sulfonate (PSS), poly(3,4-ethylenedioxythiophene) (PEDOT),), polythylene oxide (PEO), polyvinylpyrrolidone (PVP), polyacrylic acid (PAA), polyvinyl alcohol (PVA), and a copolymer thereof.

4. The lithium-sulfur secondary battery of claim 2, wherein the hydrophilic polymer is one or more selected from the group consisting of PEG, PSS, PEDOT, PEO, PVP, PAA, PVA, and a copolymer thereof.

5. The lithium-sulfur secondary battery of claim 1, wherein the conductive and liquid-retaining structure is a carbon paper, a carbon felt, a carbon veil, a gas diffusion layer (GDL), a carbon nanotube paper, or a laminated structure of two or more selected from the carbon paper, the carbon felt, the carbon veil, the GDL, and the carbon nanotube paper.

6. The lithium-sulfur secondary battery of claim 2, wherein the conductive and liquid-retaining structure is a carbon paper, a carbon felt, a carbon veil, a gas diffusion layer (GDL), a carbon nanotube paper, or a laminated structure of two or more selected from the carbon paper, the carbon felt, the carbon veil, the gas diffusion layer (GDL), and the carbon nanotube paper.

7. The lithium-sulfur secondary battery of claim 1, wherein the conductive and liquid-retaining structure has a thickness of 50 to 500 μm.

8. The lithium-sulfur secondary battery of claim 2, wherein the conductive and liquid-retaining structure has a thickness of 50 to 500 μm.

9. The lithium-sulfur secondary battery of claim 1, wherein the conductive and liquid-retaining structure has a thickness of 20 to 350 μm.

10. The lithium-sulfur secondary battery of claim 2, wherein the conductive and liquid-retaining structure has a thickness is 20 to 350 μm.

11. The lithium-sulfur secondary battery of claim 1, wherein a loading amount of the positive electrode is 3 to 10 mg/cm².

12. The lithium-sulfur secondary battery of claim 2, wherein a loading amount of the positive electrode is 3 to 10 mg/cm².

13. A method of manufacturing a lithium-sulfur secondary battery including a positive electrode, a conductive and liquid-retaining structure, and a positive electrode,
wherein the conductive and liquid-retaining structure is assembled with a negative electrode and a separation membrane after casting and laminating an active material on the positive electrode, and
wherein the conductive and liquid-retaining structure has a thickness of 5 to 100 μm, an areal weight of 10 to 120 g/m², and a porosity of 70 to 95% and is coated with a hydrophilic polymer.

14. The method of claim 13, wherein the conductive and liquid-retaining structure is assembled between the separation membrane and the positive electrode in a cell assembling process.

15. The method of claim 13, wherein the conductive and liquid-retaining structure is a carbon paper, a carbon felt, a carbon veil, a gas diffusion layer (GDL), a carbon nanotube paper, or a laminated structure of two or more selected from the carbon paper, the carbon felt, the carbon veil, the GDL, and the carbon nanotube paper.

16. The method of claim 13, wherein the conductive and liquid-retaining structure has a thickness of 50 to 500 μm.

17. The method of claim 13, wherein the conductive and liquid-retaining structure has a thickness of 20 to 350 μm.

18. The method of claim 13, wherein a loading amount of the positive electrode is 3 to 10 mg/cm².
